(19) United States
(12) Patent Application Publication
(10) Pub. No.: US 2026/0141032 A1
(43) Pub. Date: May 21, 2026

(54) SYSTEM AND METHOD FOR PREDICTING PERFORMANCE BY CLUSTERING PSYCHOMETRIC DATA USING ARTIFICIAL INTELLIGENCE

(71) Applicant: CAE INC., Saint-Laurent (CA)

(72) Inventors: Jean-François DELISLE, Saint-Laurent (CA); Anthoine DUFOUR, Saint-Laurent (CA); Bincy Baburaj NARATH, Toronto (CA)

(21) Appl. No.: 18/703,215

(22) PCT Filed: Oct. 20, 2023
(86) PCT No.: PCT/CA2022/051550

§ 371 Date: Apr. 19, 2024

Related U.S. Application Data
(60) Provisional application No. 63/257,863, filed on Oct. 20, 2021.

(51) Int. Cl. G06F 18/231; G06F 3/01; G09B 9/08

(52) U.S. Cl. CPC G06F 18/231; G06F 3/011; G09B 9/08

(57) ABSTRACT

A system for predicting performance of a student based on psychometric data includes data storage devices for storing psychometric data for students obtained via psychometric tests, the psychometric data being indicative of a plurality of psychological traits of the students. A training management system having one or more simulation stations collects performance data for the students. One or more processors executing an artificial intelligence module clusters the psychological traits define aptitude clusters and correlates the aptitude clusters with the performance data to thereby associate different levels of performance with each of the plurality of aptitude clusters. A new student performance prediction module receives a set of new psychometric data for a new student and associates the set of new psychometric data for the new student with one of the plurality of aptitude clusters to thereby predict the performance of the new student.

### TECHNICAL FIELD

The present invention relates to computer-based training systems and methods and, more particularly, to techniques for predicting the performance of students being trained by these training systems and methods.

### BACKGROUND

Various training systems and methods are known for training students to operate a complex machine such as, for example, an aircraft, warship, spacecraft, nuclear power station, etc. Training courses may involve a mix of simulations, e.g., using flight simulators or other machine simulators, and theoretical lessons. These training courses tend to be long and expensive. For example, it typically takes about 72 weeks to train a student pilot (or cadet pilot) to become a pilot with the necessary skills to obtain a commercial pilot license (CPL) with instrument rating (IR) on multi-engine (ME) aircraft and to subsequently successfully operate as a first officer on multi-pilot and multi-engine airplanes in commercial air transport. To begin the training program, the cadet pilot has to meet strict prerequisites. Despite these strict prerequisites, some cadet pilots do not succeed and, as a consequence, valuable resources are wasted.

Due to the significant time and cost of training a student, it is highly desirable to be able to predict how well a particular student will perform prior to initiating the training course for the student.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, the present invention provides a system, method and computer-readable medium for predicting a performance of a student in a training course designed to train the student to operate a complex machine such as, for example, an aircraft, warship, spacecraft, nuclear power station, etc. The system, method and computer-readable medium employ an artificial intelligence module to cluster psychological traits of students to define a plurality of aptitude clusters and to correlate the aptitude clusters with performance data from simulation training (or from flying actual aircraft) to thereby associate different levels of performance with each of the plurality of aptitude clusters. The system, method and computer-readable medium also employ a new student performance prediction module to receive a set of new psychometric data for a new student seeking to learn to operate the machine. The new student performance prediction module associates the set of new psychometric data for the new student with a selected one of the plurality of aptitude clusters to thereby predict the performance of the new student. This system, method and computer-readable medium are therefore able to predict the performance of a student. This system, method and computer-readable medium are also able to predict which type of machine (e.g., which type of aircraft) the student will be best suited to operate upon graduation thereby enabling students to be placed in appropriate training courses

A first aspect of the present disclosure is a system for predicting performance of a student seeking to learn to operate an actual machine based on psychometric data relating to the student. The system includes one or more data storage devices for storing a database of psychometric data relating to a plurality of students who have completed a training course that trains the students to operate the actual machine, the psychometric data having been obtained via psychometric tests taken by the students, the psychometric data being indicative of a plurality of psychological traits of the students. The system also includes a training management system comprising one or more simulation stations that present interactive computer simulations of the actual machine to the students, the one or more simulation stations having tangible instrumentation enabling the student to operate a simulated machine as a virtual representation of the actual machine in the interactive computer simulations as part of the training course, the training management system collecting performance data for the students. The system also includes one or more processors executing an artificial intelligence module configured to cluster the psychological traits of the students to define a plurality of aptitude clusters and to correlate the aptitude clusters with the performance data to thereby associate different levels of performance with each of the plurality of aptitude clusters. The system also includes a new student performance prediction module executed by the one or more processors and configured to receive a set of new psychometric data for a new student seeking to learn to operate the actual machine, the new student performance prediction module being further configured to associate the set of new psychometric data for the new student with a selected one of the plurality of aptitude clusters to thereby predict the performance of the new student.

Related to this first aspect is a system for predicting performance of a student seeking to learn to operate an actual machine based on psychometric data relating to the student, the system comprising one or more processors executing computer-readable code from a computer-readable medium to obtain the psychometric data relating to a plurality of students who have completed a training course that trains the students to operate the actual machine, the psychometric data having been obtained via psychometric tests taken by the students, the psychometric data being indicative of a plurality of psychological traits of the students, cluster the psychological traits of the students to define a plurality of aptitude clusters and to correlate the aptitude clusters with performance data from simulation training to thereby associate different levels of performance with each of the plurality of aptitude clusters and receive a set of new psychometric data for a new student seeking to learn to operate the actual machine, the new student performance prediction module being further configured to associate the set of new psychometric data for the new student with a selected one of the plurality of aptitude clusters to thereby predict the performance of the new student.

A second aspect of the present disclosure is a computer-implemented method of predicting performance of a student seeking to learn to operate an actual machine based on psychometric data relating to the student. The method entails storing a database of psychometric data relating to a plurality of students who have completed a training course that trains the students to operate the actual machine, the psychometric data having been obtained via psychometric tests taken by the students, the psychometric data being indicative of a plurality of psychological traits of the students. The method further entails collecting performance data for the students training on one or more simulation stations that present interactive computer simulations of the actual machine to the students, the one or more simulation stations having tangible instrumentation enabling the student to operate a simulated machine as a virtual representation of the actual machine in the interactive computer simulations as part of the training course. The method entails using an artificial intelligence module to cluster the psychological traits of the students to define a plurality of aptitude clusters and to correlate the aptitude clusters with the performance data to thereby associate different levels of performance with each of the plurality of aptitude clusters. The method further entails receiving a set of new psychometric data for a new student seeking to learn to operate the actual machine and associating the set of new psychometric data for the new student with a selected one of the plurality of aptitude clusters to thereby predict the performance of the new student.

Related to this second aspect is a computer-implemented method of predicting performance of a student seeking to learn to operate an actual machine based on psychometric data relating to the student. The method comprises obtaining the psychometric data relating to a plurality of students who have completed a training course that trains the students to operate the actual machine, the psychometric data having been obtained via psychometric tests taken by the students, the psychometric data being indicative of a plurality of psychological traits of the students. The method entails using an artificial intelligence module to cluster the psychological traits of the students to define a plurality of aptitude clusters and to correlate the aptitude clusters with the performance data to thereby associate different levels of performance with each of the plurality of aptitude clusters. The method entails receiving a set of new psychometric data for a new student seeking to learn to operate the actual machine and associating the set of new psychometric data for the new student with a selected one of the plurality of aptitude clusters to thereby predict the performance of the new student.

A third aspect of the present disclosure is a non-transitory computer-readable medium having computer-readable code which is executable by a processor (or one or more processors) to store a database of psychometric data relating to a plurality of students who have completed a training course that trains the students to operate an actual machine, the psychometric data having been obtained via psychometric tests taken by the students, the psychometric data being indicative of a plurality of psychological traits of the students. The code also causes the one or more processors to collect performance data for the students training on one or more simulation stations that present interactive computer simulations of the actual machine to the students, the one or more simulation stations having tangible instrumentation enabling the student to operate a simulated machine as a virtual representation of the actual machine in the interactive computer simulations as part of the training course. The code also causes the one or more processors to execute an artificial intelligence module to cluster the psychological traits of the students to define a plurality of aptitude clusters and to correlate the aptitude clusters with the performance data to thereby associate different levels of performance with each of the plurality of aptitude clusters. The code further causes the one or more processors to receive a set of new psychometric data for a new student seeking to learn to operate the actual machine and associating the set of new psychometric data for the new student with a selected one of the plurality of aptitude clusters to thereby predict the performance of the new student.

Related to this third aspect is a non-transitory computer-readable medium storing instructions in code which when executed by one or more processors cause the one or more processors to obtain the psychometric data relating to a plurality of students who have completed a training course that trains the students to operate the actual machine, the psychometric data having been obtained via psychometric tests taken by the students, the psychometric data being indicative of a plurality of psychological traits of the students. The code further causes the one or more processors to execute an artificial intelligence module to cluster the psychological traits of the students to define a plurality of aptitude clusters and to correlate the aptitude clusters with the performance data to thereby associate different levels of performance with each of the plurality of aptitude clusters. The code causes the one or more processors to receive a set of new psychometric data for a new student seeking to learn to operate the actual machine and associating the set of new psychometric data for the new student with a selected one of the plurality of aptitude clusters to thereby predict the performance of the new student.

### BRIEF DESCRIPTION OF THE DRAWINGS

Further features and exemplary advantages of the present invention will become apparent from the following detailed description, taken in conjunction with the appended drawings, in which:

FIG. 1 is a schematic representation of an exemplary system for predicting performance by clustering psychometric data using artificial intelligence in accordance with an embodiment of the present invention;

FIG. 2 is a schematic representation of a simulation system having simulation stations for use in the system of FIG. 1;

FIG. 3 is a flowchart of a method of predicting performance by clustering psychometric data using artificial intelligence in accordance with an embodiment of the present invention;

FIG. 4 is a flowchart of a related method of refining the predicted performance using improvement data;

FIG. 5 is a schematic diagram showing how the system presented in FIG. 1 can be adapted for pilot training;

FIG. 6 is a dendrogram of agglomerative hierarchical clustering, showing four clusters;

FIG. 7 is a bar chart showing a student performance label distribution across various courses;

FIG. 8 is a graphical cluster representation showing cluster formation using agglomerative hierarchical clustering;

FIG. 9 is a graphical representation of fifteen defining features of individual clusters;

FIG. 10A is an example pie chart showing overall predicted performance for a first cluster;

FIG. 10B is an exemplary pie chart showing overall predicted performance for a second cluster;

FIG. 10C is an exemplary pie chart showing overall predicted performance for a third cluster; and

FIG. 10D is an exemplary pie chart showing overall predicted performance for a fourth cluster.

### DETAILED DESCRIPTION

Disclosed herein is a system, method and computer-readable medium that utilize an artificial intelligence module to cluster psychological traits of students, the psychological traits having been obtained via psychometric testing, to define a plurality of aptitude clusters and to correlate the aptitude clusters with performance data from simulation training to thereby associate different levels of performance with each of the plurality of aptitude clusters. This enables the efficient selection of new students for admission into training courses based on their psychometric testing.

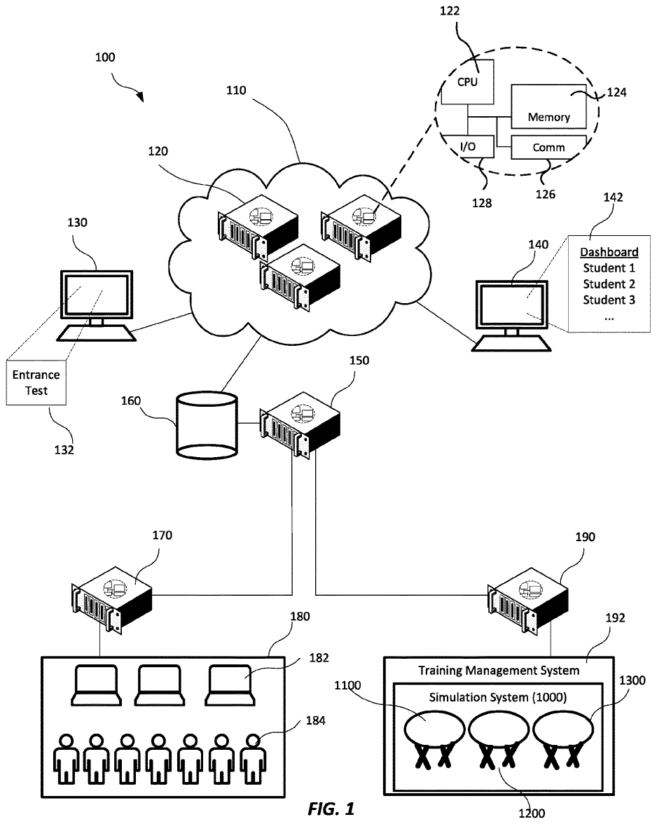

FIG. 1 depicts a system 100 for predicting performance of a student in accordance with an embodiment of the present invention. The student is a person seeking to learn to operate a machine, i.e., an actual (real-world) machine. A machine may be a vehicle such as an aircraft, ship, spacecraft or the like. The machine may also be non-vehicular equipment such as a power station, healthcare or medical system, cybersecurity system, or the like. The student is evaluated based on psychometric data relating to the student using an artificial intelligence module that classifies the student based on clusters of psychological traits (also known herein as aptitude clusters) and then predicts the performance of the student based on the correlation between performance and the aptitude cluster to which the student pertains.

In the embodiment depicted by way of example in FIG. 1, the system 100 includes a cloud-based artificial intelligence module 110 implemented over a plurality of networked servers 120, computers or other computing devices. Each server has one or more processors (e.g., a CPU) 122, a memory 124 (e.g., both volatile and non-volatile memory), a communications module 126, and input-output (I/O) ports 128. The system 100 optionally includes a first user computer device 130 (e.g., a personal desktop computer, laptop, tablet, mobile communication device, etc.) associated with a new student that presents and administers one or more psychometric tests (“entrance test” 132) to a new student. The system 100 may also optionally include a second user computing device 140 associated with an instructor, trainer, teacher, supervisor or manager who uses to the second user computing device 140 to view performance prediction results for one or more students on a dashboard 142 or in any other suitable graphical or textual form. The artificial intelligence module 110 evaluates the psychometric data of the new student by associating the new student with one of a plurality of aptitude clusters which have been previously generated by the artificial intelligence module 110 using a large body of data obtained from prior students as will be explained below. From the foregoing, it is understood that, in one embodiment, the first and second user computing devices 130, 140 may be external to the system 100, i.e., the first and second user computing devices 130, 140 are not part of the system but rather interact with the system 100. In another embodiment, however, the system 100 may include one or both of the first and second user computing devices 130, 140.

As depicted in FIG. 1, the system 100 optionally includes one or more data storage devices 160 (e.g. computer memory) for storing a database of psychometric data relating to a plurality of students who have completed a training course that trains the students to operate the machine. The psychometric data is obtained via psychometric tests (i.e., psychological tests) taken by the students. The psychometric data is indicative of a plurality of psychological traits of the students. Examples of psychological traits include, but are not limited to, trustworthiness, honesty, rule-compliance, loyalty, risk-tolerance, anger management, stability, neuroticism, self-awareness, intelligence, introversion, friendliness, etc. The system optionally includes a data acquisition module (implemented in this example on a data acquisition server 150) that obtains the psychometric data for the students and also obtains simulation performance data for the students. In this example architecture, the data acquisition server 150 is networked to both a psychometric database server 170 and a training management system server 190. The psychometric database server 170 may be connected to a psychometric evaluation environment 180 having computing devices 182 for evaluating a plurality of students 184. Alternatively or additionally, the psychometric database server 170 may be linked to the first user computing device 130 to obtain data from new students.

As depicted in FIG. 1, the training management system server 190 is connected to a training management system 192 which includes an interactive computer simulation system 1000 having one or more simulation stations 1100, 1200, 1300 that present interactive computer simulations of the actual machine to the students. The one or more simulation stations 1100, 1200, 1300 each have tangible instrumentation enabling the student to operate a simulated machine as a virtual representation of the actual machine in the interactive computer simulations as part of the training course. The training management system server 190 collects performance data for the students and shares this performance data with the data acquisition server 150. In the particular case of pilot training, the actual machine is an aircraft and the simulation stations are flight simulators.

In the system of FIG. 1, the one or more processors 122 of the servers 120 of the artificial intelligence module 110 provide artificial intelligence that clusters the psychological traits of the students (from the psychometric database server 170) to define a plurality of aptitude clusters and correlates the aptitude clusters with the performance data (from the training management system server 190). This enables the artificial intelligence to associate different levels of performance with each of the plurality of aptitude clusters. In one implementation, the artificial intelligence module clusters the psychological traits using hierarchical agglomerative clustering although other clustering algorithms may be employed as will be described below.

When a new student is considered for admission to a training course, the artificial intelligence module 110 of the system 100 predicts the performance of the new student on the basis of psychometric testing. This technology enables a more efficient filtering of students that are new to the training course. As described above the new student undergoes psychometric testing using for example the first user computing device 130. This psychometric testing produces a set of new psychometric data for the new student. The artificial intelligence module 110 uses this set of new psychometric data for the new student to predict the performance of the new student by associating the set of new psychometric data for the new student with a selected one of the plurality of aptitude clusters to thereby predict the performance of the new student. In other words, the new student is classified as falling within one of the aptitude clusters. The performance of the new student is then predicted by attributing the predicted performance of the aptitude cluster with which the new student is associated. In one embodiment, the artificial intelligence module 110 may have a new student performance prediction module that is executed by the one or more processors 120. The new student performance prediction module is configured to receive the set of new psychometric data for the new student seeking to learn to operate the machine and associate the set of new psychometric data with a selected one of the plurality of aptitude clusters to thereby predict the performance of the new student. In another embodiment, the new student performance prediction module may be distinct from the artificial intelligence module 110. In this embodiment, the new student performance prediction module cooperates with the artificial intelligence module 110 to predict performance based on the clustering and classifications performed by the artificial intelligence module 110.

In one embodiment, the system optionally includes a simulation input device (e.g., joystick) connected to a personal computing device that is controlled by the student during an elementary (game-style) simulation of the machine from which psychomotor data indicative of the psychomotor skills of the student is obtained. The one or more processors of the artificial intelligence module 110 may predict the performance of the student also on the basis of the psychomotor data obtained from the video game simulation, e.g., a video game flight simulator, or on the basis of an initial psychomotor evaluation of the new student generated from the psychomotor data.

In one embodiment, as will be described in greater detail below, the one or more processors 122 are configured to generate performance improvement data indicative of how a student is improving over time during the training course. The improvement data may be used to refine the performance prediction.

In one embodiment, the artificial intelligence module 110 generates an individualized training plan based on the selected one of the aptitude clusters and communicates the individualized training plan to a user computing device to be presented to the new student or to a user involved in training the new student. The individualized training plan provides a personalized training program for the student. For example, in the context in pilot training, the individualized training plan may prescribe flight simulation exercises, theoretical lessons or other learning experiences to develop the knowledge, skills and aptitude of student.

In one embodiment, the artificial intelligence module generates a student-machine affinity profile based on the aptitude clusters selected by the artificial intelligence module 110 and communicates the student-machine affinity profile to a user computing device to be presented to the new student or to a user involved in training the new student. The student-machine affinity profile is indicative of which type of machine the student is most suited to operate. For example, in the context of pilot training, the student-machine affinity profile may indicate the type of aircraft that the student will be most suited to fly, e.g., fighter jet, transport, civilian passenger airliner, etc. Alternatively, the student-machine affinity profile may indicate the type of role the student (upon graduation) should occupy, e.g., fighter pilot, bomber pilot, transport pilot, instructor, etc.

The performance data that is used by the artificial intelligence (AI) module 110 is obtained, as noted above, from student performance data during simulation training. The simulation stations 1200, 1300 are part of an interactive computer simulation system 1000 within a training management system or platform. Alternatively, or additionally, the performance data may be obtained from measuring the performance of student pilots flying actual aircraft, i.e., real-world flight operations.

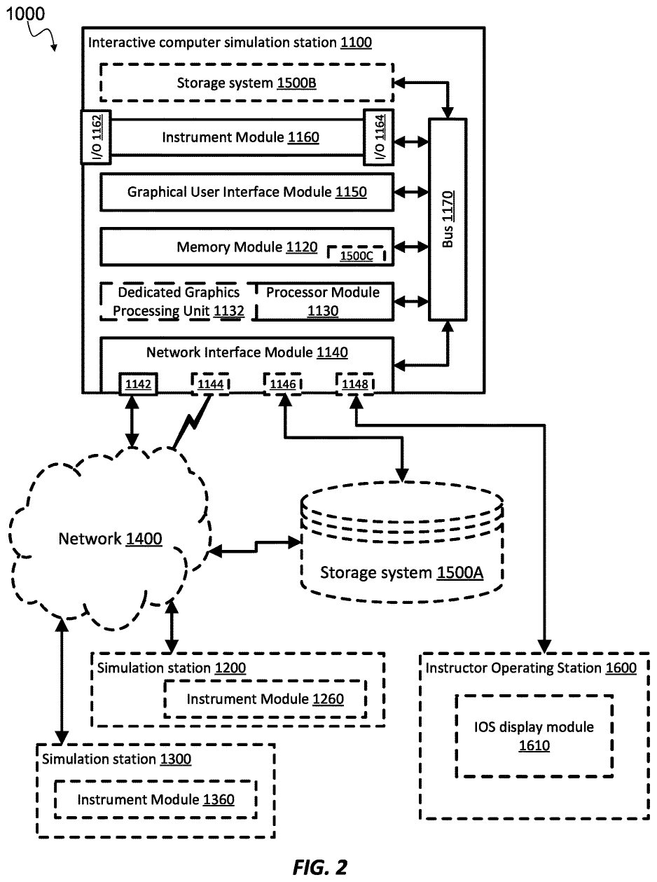

FIG. 2 shows a logical modular representation of an exemplary interactive computer simulation system 1000 providing an interactive computer simulation of a simulated interactive object (i.e., the simulated machine). The interactive computer simulation system 1000 comprises one or more interactive computer simulation stations 1100, 1200, 1300 which may be executing one or more interactive computer simulations such as a flight simulation software for instance.

In the depicted example of FIG. 2, the interactive computer simulation station 1100 comprises a memory module 1120, a processor module 1130 and a network interface module 1140. The processor module 1130 may represent a single processor with one or more processor cores or an array of processors, each comprising one or more processor cores. In some embodiments, the processor module 1130 may also comprise a dedicated graphics processing unit 1132. The dedicated graphics processing unit 1132 may be required, for instance, when the interactive computer simulation system 1000 performs an immersive simulation (e.g., pilot training-certified flight simulator), which requires extensive image generation capabilities (i.e., quality and throughput) to maintain the level of realism expected of such immersive simulation (e.g., between 5 and 60 images rendered per second or a maximum rendering time ranging between 15 ms and 200 ms for each rendered image). In some embodiments, each of the simulation stations 1200, 1300 comprises a processor module similar to the processor module 1130 and having a dedicated graphics processing unit similar to the dedicated graphics processing unit 1132. The memory module 1120 may comprise various types of memory (different standardized or kinds of Random-Access Memory (RAM) modules, memory cards, Read-Only Memory (ROM) modules, programmable ROM, etc.). The network interface module 1140 represents at least one physical interface that can be used to communicate with other network nodes. The network interface module 1140 may be made visible to the other modules of the computer system 1000 through one or more logical interfaces. The actual stacks of protocols used by physical network interface(s) and/or logical network interface(s) 1142, 1144, 1146, 1148 of the network interface module 1140 do not affect the teachings of the present invention. The variants of the processor module 1130, memory module 1120 and network interface module 1140 that are usable in the context of the present invention will be readily apparent to persons skilled in the art.

A bus 1170 is depicted as an example of means for exchanging data between the different modules of the computer simulation system 1000. The present invention is not affected by the way the different modules exchange information between them. For instance, the memory module 1120 and the processor module 1130 could be connected by a parallel bus, but could also be connected by a serial connection or involve an intermediate module (not shown) without affecting the teachings of the present invention.

Likewise, even though explicit references to the memory module 1120 and/or the processor module 1130 are not made throughout the description of the various embodiments, persons skilled in the art will readily recognize that such modules are used in conjunction with other modules of the computer simulation system 1000 to perform routine as well as innovative steps related to the present invention.

The interactive computer simulation station 1100 also comprises a Graphical User Interface (GUI) module 1150 comprising one or more display screen(s). The display screens of the GUI module 1150 could be split into one or more flat panels, but could also be a single flat or curved screen visible from an expected user position (not shown) in the interactive computer simulation station 1100. For instance, the GUI module 1150 may comprise one or more mounted projectors for projecting images on a curved refracting screen. The curved refracting screen may be located far enough from the user of the interactive computer program to provide a collimated display. Alternatively, the curved refracting screen may provide a non-collimated display.

The computer simulation system 1000 comprises a storage system 1500A-C that may log dynamic data in relation to the dynamic sub-systems while the interactive computer simulation is performed. FIG. 2 shows examples of the storage system 1500A-C as a distinct database system 1500A, a distinct module 1500B of the interactive computer simulation station 1100 or a sub-module 1500C of the memory module 1120 of the interactive computer simulation station 1100. The storage system 1500A-C may also comprise storage modules (not shown) on the interactive computer simulation stations 1200, 1300. The storage system 1500A-C may be distributed over different systems A, B, C and/or the interactive computer simulations stations 1200, 1300 or may be in a single system. The storage system 1500A-C may comprise one or more logical or physical as well as local or remote hard disk drive (HDD) (or an array thereof). The storage system 1500A-C may further comprise a local or remote database made accessible to the interactive computer simulation station 1100 by a standardized or proprietary interface or via the network interface module 1140. The variants of the storage system 1500A-C usable in the context of the present invention will be readily apparent to persons skilled in the art.

An Instructor Operating Station (IOS) 1600 may be provided for allowing various management tasks to be performed in the interactive computer simulation system 1000. The tasks associated with the IOS 1600 allow for control and/or monitoring of one or more ongoing interactive computer simulations. For instance, the IOS 1600 may be used for allowing an instructor to participate in the interactive computer simulation and possibly additional interactive computer simulation(s). In some embodiments, a distinct instance of the IOS 1600 may be provided as part of each one of the interactive computer simulation stations 1100, 1200, 1300. In other embodiments, a distinct instance of the IOS 1600 may be co-located with each one of the interactive computer simulation stations 1100, 1200, 1300 (e.g., within the same room or simulation enclosure) or remote therefrom (e.g., in different rooms or in different locations). Skilled persons will understand that many instances of the IOS 1600 may be concurrently provided in the computer simulation system 1000. The IOS 1600 may provide a computer simulation management interface, which may be displayed on a dedicated IOS display module 1610 or the GUI module 1150. The IOS 1600 may be physically co-located with one or more of the interactive computer simulation stations 1100, 1200, 1300 or it may be situated at a location remote from the one or more interactive computer simulation stations 1100, 1200, 1300.

The IOS display module 1610 may comprise one or more display screens such as a wired or wireless flat screen, a wired or wireless touch-sensitive display, a tablet computer, a portable computer or a smart phone. When multiple interactive computer simulation stations 1100, 1200, 1300 are present in the interactive computer simulation system 1000, the instance of the IOS 1600 may present different views of the computer program management interface (e.g., to manage different aspects therewith) or they may all present the same view thereof. The computer program management interface may be permanently shown on a first of the screens of the IOS display module 1610 while a second of the screen of the IOS display module 1610 shows a view of the interactive computer simulation being presented by one of the interactive computer simulation stations 1100, 1200, 1300). The computer program management interface may also be triggered on the IOS 1600, e.g., by a touch gesture and/or an event in the interactive computer program (e.g., milestone reached, unexpected action from the user, or action outside of expected parameters, success or failure of a certain mission, etc.). The computer program management interface may provide access to settings of the interactive computer simulation and/or of the computer simulation stations 1100, 1200, 1300. A virtualized IOS (not shown) may also be provided to the user on the IOS display module 1610 (e.g., on a main screen, on a secondary screen or a dedicated screen thereof). In some embodiments, a Brief and Debrief System (BDS) may also be provided. In some embodiments, the BDS is a version of the IOS configured to selectively play back data recorded during a simulation session.

The tangible instrument provided by the instrument modules 1160, 1260 and/or 1360 are closely related to the element being simulated. In the example of the simulated aircraft system, for instance, in relation to an exemplary flight simulator embodiment, the instrument module 1160 may comprise a control yoke and/or side stick, rudder pedals, a throttle, a flap switch, a transponder, a landing gear lever, a parking brake switch, and aircraft instruments (air speed indicator, attitude indicator, altimeter, turn coordinator, vertical speed indicator, heading indicator, etc). Depending on the type of simulation (e.g., level of immersivity), the tangible instruments may be more or less realistic compared to those that would be available in an actual aircraft. For instance, the tangible instruments provided by the instrument module(s) 1160, 1260 and/or 1360 may replicate those found in an actual aircraft cockpit or be sufficiently similar to those found in an actual aircraft cockpit for training purposes. As previously described, the user or trainee can control the virtual representation of the simulated interactive object in the interactive computer simulation by operating the tangible instruments provided by the instrument modules 1160, 1260 and/or 1360. In the context of an immersive simulation being performed in the computer simulation system 1000, the instrument module(s) 1160, 1260 and/or 1360 would typically replicate of an instrument panel found in the actual interactive object being simulated. In such an immersive simulation, the dedicated graphics processing unit 1132 would also typically be required. While the present invention is applicable to immersive simulations (e.g., flight simulators certified for commercial pilot training and/or military pilot training), skilled persons will readily recognize and be able to apply its teachings to other types of interactive computer simulations.

In some embodiments, an optional external input/output (I/O) module 1162 and/or an optional internal input/output (I/O) module 1164 may be provided with the instrument module 1160. Skilled people will understand that any of the instrument modules 1160, 1260 and/or 1360 may be provided with one or both of the I/O modules 1162, 1164 such as the ones depicted for the computer simulation station 1100. The external input/output (I/O) module 1162 of the instrument module(s) 1160, 1260 and/or 1360 may connect one or more external tangible instruments (not shown) therethrough. The external I/O module 1162 may be required, for instance, for interfacing the computer simulation station 1100 with one or more tangible instruments identical to an Original Equipment Manufacturer (OEM) part that cannot be integrated into the computer simulation station 1100 and/or the computer simulation station(s) 1200, 1300 (e.g., a tangible instrument exactly as the one that would be found in the interactive object being simulated). The internal input/output (I/O) module 1162 of the instrument module(s) 1160, 1260 and/or 1360 may connect one or more tangible instruments integrated with the instrument module(s) 1160, 1260 and/or 1360. The I/O module 1162 may comprise necessary interface(s) to exchange data, set data or get data from such integrated tangible instruments. The internal I/O module 1162 may be required, for instance, for interfacing the computer simulation station 1100 with one or more integrated tangible instruments that are identical to an Original Equipment Manufacturer (OEM) part that would be found in the interactive object being simulated. The I/O module 1162 may comprise necessary interface(s) to exchange data, set data or get data from such integrated tangible instruments.

The instrument module 1160 may comprise one or more tangible instrumentation components or subassemblies that may be assembled or joined together to provide a particular configuration of instrumentation within the computer simulation station 1100. As can be readily understood, the tangible instruments of the instrument module 1160 are configured to capture input commands in response to being physically operated by the user of the computer simulation station 1100.

The instrument module 1160 may also comprise a mechanical instrument actuator 1166 providing one or more mechanical assemblies for physical moving one or more of the tangible instruments of the instrument module 1160 (e.g., electric motors, mechanical dampeners, gears, levers, etc.). The mechanical instrument actuator 1166 may receive one or more sets of instruments (e.g., from the processor module 1130) for causing one or more of the instruments to move in accordance with a defined input function. The mechanical instrument actuator 1166 of the instrument module 1160 may alternatively, or additionally, be used for providing feedback to the user of the interactive computer simulation through tangible and/or simulated instrument(s) (e.g., touch screens, or replicated elements of an aircraft cockpit or of an operating room). Additional feedback devices may be provided with the computing device 1110 or in the computer system 1000 (e.g., vibration of an instrument, physical movement of a seat of the user and/or physical movement of the whole system, etc.).

The interactive computer simulation station 1100 may also comprise one or more seats (not shown) or other ergonomically designed tools (not shown) to assist the user of the interactive computer simulation in getting into proper position to gain access to some or all of the instrument module 1160.

In the depicted example of FIG. 2, the interactive computer simulation station 1100 shows optional interactive computer simulation stations 1200, 1300, which may communicate through the network 1400 with the simulation computing device. The stations 1200, 1300 may be associated to the same instance of the interactive computer simulation with a shared computer-generated environment where users of the computer simulation stations 1100, 1200, 1300 may interact with one another in a single simulation. The single simulation may also involve other simulation computer simulation stations (not shown) co-located with the computer simulation stations 1100, 1200, 1300 or remote therefrom. The computer simulation stations 1200, 1300 may also be associated with different instances of the interactive computer simulation, which may further involve other computer simulation stations (not shown) co-located with the computer simulation station 1100 or remote therefrom.

In the context of the depicted embodiments, runtime execution, real-time execution or real-time priority processing execution corresponds to operations executed during the interactive computer simulation that may have an impact on the perceived quality of the interactive computer simulation from a user perspective. An operation performed at runtime, in real time or using real-time priority processing thus typically needs to meet certain performance constraints that may be expressed, for instance, in terms of maximum time, maximum number of frames, and/or maximum number of processing cycles. For instance, in an interactive simulation having a frame rate of 60 frames per second, it is expected that a modification performed within 5 to 10 frames will appear seamless to the user. Skilled persons will readily recognize that real-time processing may not actually be achievable in absolutely all circumstances in which rendering images is required. The real-time priority processing required for the purpose of the disclosed embodiments relates to the perceived quality of service by the user of the interactive computer simulation and does not require absolute real-time processing of all dynamic events, even if the user was to perceive a certain level of deterioration in the quality of the service that would still be considered plausible.

A simulation network (e.g., overlaid on the network 1400) may be used, at runtime (e.g., using real-time priority processing or processing priority that the user perceives as real-time), to exchange information (e.g., event-related simulation information). For instance, movements of a vehicle associated with the computer simulation station 1100 and events related to interactions of a user of the computer simulation station 1100 with the interactive computer-generated environment may be shared through the simulation network. Likewise, simulation-wide events (e.g., related to persistent modifications to the interactive computer-generated environment, lighting conditions, modified simulated weather, etc.) may be shared through the simulation network from a centralized computer system (not shown). In addition, the storage module 1500A-C (e.g., a networked database system) accessible to all components of the computer simulation system 1000 involved in the interactive computer simulation may be used to store data necessary for rendering the interactive computer-generated environment. In some embodiments, the storage module 1500A-C is only updated from the centralized computer system and the computer simulation stations 1200, 1300 only load data therefrom.

The computer simulation system 1000 of FIG. 2 may be used to simulate the operation by a user of a user vehicle. For example, in a flight simulator, the interactive computer simulation system 1000 may be used to simulate the flying of an aircraft by a user acting as the pilot of the simulated aircraft. In a battlefield simulator, the simulator may simulate a user controlling one or more user vehicles such as airplanes, helicopters, warships, tanks, armored personnel carriers, etc. In both examples, the simulator may simulate an external vehicle (referred to herein as a simulated external vehicle) that is distinct from the user vehicle and not controlled by the user.

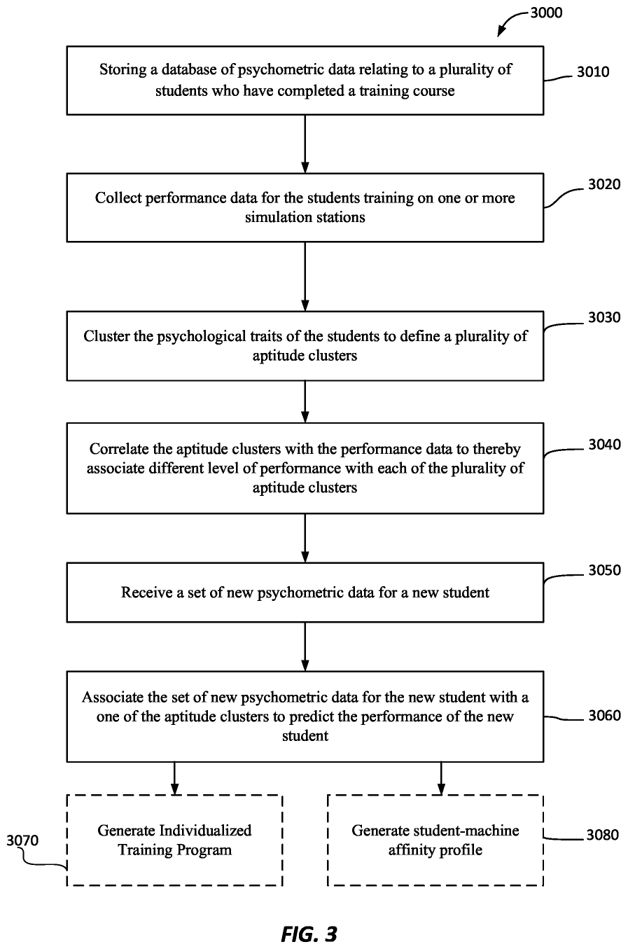

FIG. 3 presents a flowchart depicting a computer-implemented method of predicting performance of a student seeking to learn to operate a machine based on psychometric data relating to the student. As depicted in FIG. 3, the method 3000 entails a step, act or operation of storing 3010 a database of psychometric data relating to a plurality of students who have completed a training course that trains the students to operate the machine. The psychometric data is obtained via psychometric tests taken by the students. The psychometric data is indicative of a plurality of psychological traits of the students. The method further entails collecting 3020 performance data for the students training on one or more simulation stations that present interactive computer simulations of the machine to the students. The one or more simulation stations have tangible instrumentation enabling the student to operate a simulated machine as a virtual representation of the machine in the interactive computer simulations as part of the training course. The method entails using an artificial intelligence module to cluster 3030 the psychological traits of the students to define a plurality of aptitude clusters and to correlate 3040 the aptitude clusters with the performance data to thereby associate different levels of performance with each of the plurality of aptitude clusters. This part of the method creates a data set used to evaluate new students. The method 3000 further entails receiving 3050 a set of new psychometric data for a new student seeking to learn to operate the machine and associating 3060 the set of new psychometric data for the new student with a selected one of the plurality of aptitude clusters to thereby predict the performance of the new student.

Optionally, as depicted in FIG. 3, the method entails generating 3070 an individualized training plan based on the selected one of the aptitude clusters. The individualized training plan may be communicated to a user computing device to be presented to the new student and/or to a user involved in training the new student, i.e., a teacher or instructor. The individualized training plan provides a personalized training program for the student. For example, in the context of pilot training, the individualized training plan may propose a course with various combinations or permutations of lessons of varying type, depth and complexity, e.g. simulator lessons, theoretical lessons, remedial lessons, etc.

Optionally, as depicted in FIG. 3, the method entails generating 3080 a student-machine affinity profile based on the selected one of the aptitude clusters. This student-machine affinity profile may be communicated to a user computing device to be presented to the new student and/or to a user involved in training the new student, i.e., a teacher or instructor. The student-machine affinity profile is indicative of which type of machine the student is most suited to operate. For example, in the context of pilot training, the type of machine is the type of aircraft, e.g., fighter jet, long-range bomber, electronic warfare aircraft, military transport plane, search and rescue aircraft, helicopter, commercial passenger airliner, etc.

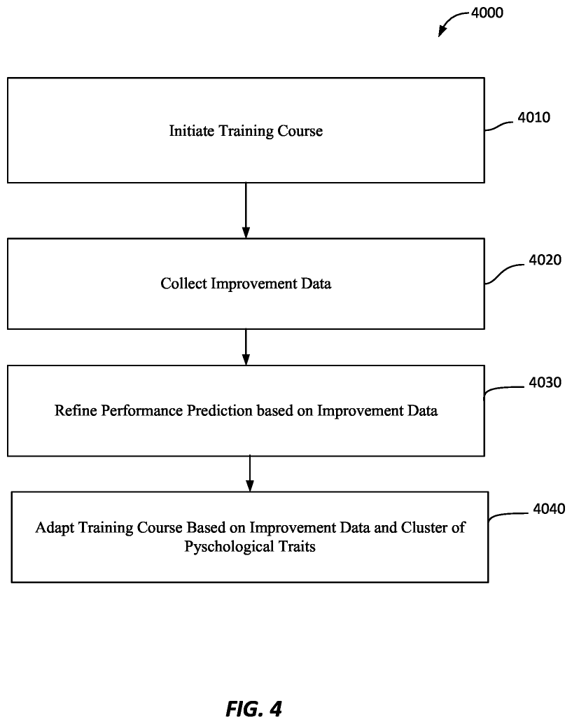

FIG. 4 presents a flowchart depicting a method 4000 of refining the performance prediction based on improvement data collected during the course. The performance prediction may be performed using the method of FIG. 3. In the method 4000, the student initiates 4010 the training course. Improvement data is collected 4020. The performance prediction is then refined 4030 based on the improvement data. Optionally, the course may be adapted or modified 4040 based on the improvement data and the cluster of psychological traits of the student.

The system and method disclosed herein are able to predict the performance, i.e., the expected performance, of students in learning to operate a machine such as an aircraft. This system and method thus facilitate the task of selecting those students that are most likely to succeed while filtering out those prospective students who are unlikely to succeed before expending considerable resources on training the students. This system and method also help identify which students are best suited for particular types of machines or operations. For example, in the context of pilot training, this system and method enable selection of student pilots most likely to successfully graduate as competent pilots. This system and method also enable the identification of different types of roles that are most suited for the psychological profile of the graduating student pilot. For example, a pilot who has greater risk tolerance may be selected for a role as a fighter jet pilot or search and rescue pilot whereas another pilot with a lower risk tolerance may be selected as a commercial passenger airliner pilot. Furthermore, the system and method enable the creation of individualized training programs based on the psychological traits of the student, thereby expediting and streamlining the training process. In other words, the psychological traits of the student are not only predictors of success (performance) but are also indicators of how best to train the student. That is, the psychological traits of the student define a learner profile that can be used to provide optimized training for the particular student.

### Example Application to Student Pilots and Flight Training

What follows is a specific example of how the system, method and computer-readable medium is used in the context of pilot training to predict the performance of student pilots (also known as cadets or pilot cadets).

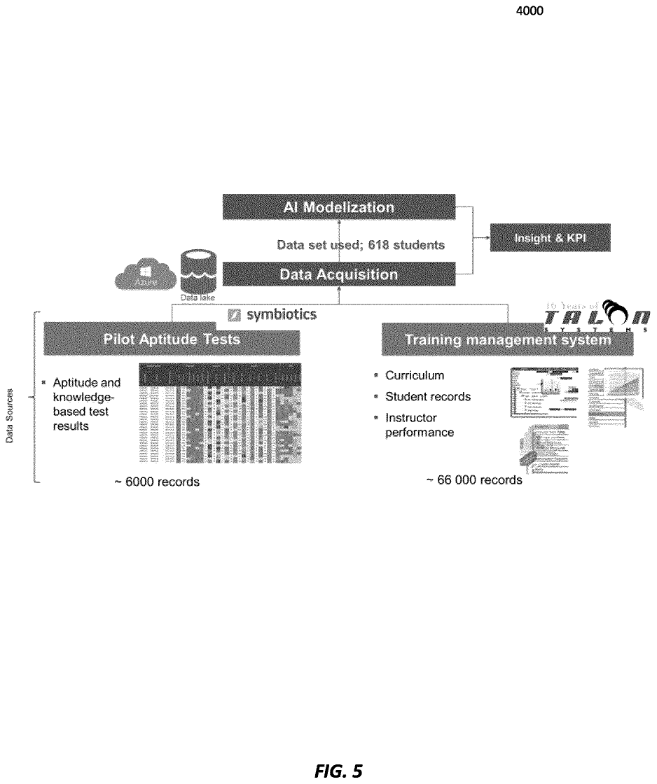

FIG. 5 is a schematic diagram showing how the system presented in FIG. 1 can be adapted for pilot training in accordance with one embodiment. As shown by way of example in FIG. 5, the system has a training management system that provides performance data to a data acquisition server. The data acquisition server also receives psychometric test data from pilot aptitude tests administered to the students (cadets). The data acquisition server stores the data in a database (“data lake”, i.e., a repository of data stored in its natural/raw format). The AI module generates a psychometric-performance model (“AI Modelisation”) to correlate the psychometric data with the performance data. This may be accomplished by clustering the psychological traits into aptitude clusters and then correlating the clusters with performance data to link the clusters with different levels of performance.

Performance data for a plurality of student pilots may involve generating extensive flight training datasets from simulation training and other coursework and evaluations. Flight training datasets are a collection of multiple datasets with records of training curricula and student performance, which may include items such as: student course location, definition, objectives, associated standard and various stages, student historical performance, and expected performance through various courses, lessons and line items, instructor comments and grading. Each course may be divided into stages. Each stage may be divided into lessons. Each lesson may be further divided into units. Each unit has multiple line items. The performance of these line items by the students in each course is recorded with associated grades. The line-item records of the students may be extracted to generate the performance data.

Psychometric data may be derived from various types of tests such as personality tests. In addition, the psychometric data may be based on various types of knowledge tests relating to topics such as math, physics, and English. Aptitude tests may be used to measure cognitive reasoning, logical reasoning, mechanical reasoning, error checking, multitasking, situation awareness and physical skills.

### Data Analysis (Clustering and Correlating)

Performance labelling is performed as an initial step in the data analysis in this embodiment. In this embodiment, the line-item grades for students (that were mentioned above) across the various courses, lessons, and units are considered to classify the students into three performance categories based on their performance in each unit. In this embodiment, students are ranked based on their overall performance in each course across the units. For example, Top 10% (of the ranks) are taken as excellent, bottom 10% as poor and the remaining as average performers. This approach is used to map the knowledge of subject matter experts in aviation training pertaining to performance using statistical methods so as to scale this approach easily across courses without specific knowledge about them.

### Clustering

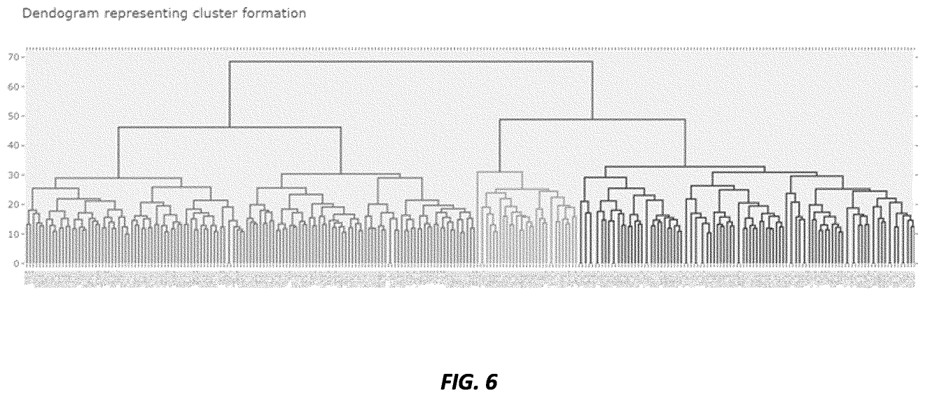

The students are clustered into groups/profiles (also referred to herein as aptitude clusters) based on the aptitude test scores on various components (outputs) of assessments. Various clustering methods have been studied and assessed on the data. Agglomerative hierarchical clustering is used in one embodiment as the best mode of clustering the data. The primary reason for choosing this method was the ability to choose a convincing distance threshold after observing a dendrogram (presented by way of example in FIG. 6) to result in four clusters and the 2D representation as well as heatmap of these clusters resulted in clear patterns. Density-based clustering methods (DBSCAN, OPTICS etc.) performed poorly on the data; though these algorithms performed on reduced dimensions, dimensionality reduction is not used due to issues of cluster explainability. Methods like Gaussian Mixture Model and K-Means were not adopted because of the requirement to input the number of clusters beforehand, prohibiting the natural formation of clusters. The algorithm for performing hierarchical agglomerative clustering is presented below:

Algorithm 1: Hierarchical Agglomerative Clustering

$Input : {\{ {X}_{n} \}}_{n = 1}^{N} {X}_{i} is the aptitude test vector of {i}^{th} student$

| | The distance threshold DT | |
|---|---|---|
| Output: | Cluster Groups Ω | |
| Initialize: | Ω ← ø | Initial cluster set starts as Null |
| | DT ← 45 | Based on dendogram |
| | DMIN ← 0 | DMIN is the minimum distance between any two clusters |
| Step 1: | for n ← 1 to N: do | Each data point is assigned as its own cluster |
| | Ω ← Ω{{Xₙ}} | |
| | end for | |
| Step 2: | while DMIN <= DT do | Choose the pair in Ω with the closest distance |
| | ${C}_{1}^{*} , {C}_{2}^{*} = {arg min}_{{C}_{1} , {C}_{2} ∈ Ω} D I S T ( {C}_{1} , {C}_{2} ) Update D M I N as the currrent minimum distance among$ | |
| | | any of the clusters in the set |
| | $D M I N ← D I S T ( {C}_{1}^{*} , {C}_{2}^{*} )$ | $Remove {C}_{1}^{*} , {C}_{2}^{*} from the cluster set$ |
| | If DMIN > DT break, else | Update the cluster set with newly formed cluster |
| | $Ω ← Ω - \{ {C}_{1}^{*} \} - \{ {C}_{2}^{*} \}$ | |
| | $Ω ← Ω U \{ {C}_{1}^{*} U {C}_{2}^{*} \}$ | |
| | end while | |
| | Return Ω | |

Four clusters are formed based on the clustering method. A supervised algorithm is trained with the clustering labels. In one embodiment, SHAP (SHapley Additive exPlanations) is used to interpret the clusters resulting in four defined characteristic groups. Macro level correlations are identified between the cluster groups and performance.

In this implementation, some key notions of performance related to the grading are as follows: the number of failed line items in a unit roughly measures the performance. However, it has to be noted that failing many line items in the initial units of a course compared to later units is expected as the grading of line items are absolute and it is based on instructor's judgement and likely to be biased. Units are of varied difficulty. While failing in 10-line items in a unit is considered poor performance, the same could be considered expected in some other units. This is typically observed in some “staging units” where instructors have to suddenly check the overall skill level of a student to allow the student to pass that stage because of some strict requirements on skillsets; many students are expected to fail relatively high number of line-items in these units. Poor performance in a unit by failing many line items cannot be considered as overall poor performance in the course; this means the poor performance in that specific unit. Some students would not have taken all the units in a course, reason being transferred from one course to the other. In this implementation, other key performance metrics are identified along with the line-item failure counts to measure the student's performance. They are as follows: (i) probability of passing a unit; (ii) the percentage of times a student falls into top, average, or bottom ranks in unit level performance across all the units in the course (iii) the average number of times (per unit) the student is graded with excellent performance (consistency rate) (iv) the average unit takes (attempts to complete the unit) (the lower the better). Based on the metrics, each student performance in each unit for all the courses in consideration were gauged as “top”, “average” and “bottom” based on the number of failed line items in those units. The top 20% (who has the least number of fail counts in the unit) would be tagged as “top” in that unit. Similarly, bottom 20% as “bottom” and the remaining as “average”. The probability of being a “top”, “average”, “bottom” performer in a unit is calculated for each of the student in all the courses under consideration as follows:

$$P ( student , tag , course ) = \frac{Unit {Count}_{student , tag , course}}{Unit {Count}_{student , course}}$$

Here, Unit Count_{student,course} is the total number of units student has taken in the course; while Unit Count_{student,course} is the total number of units student has taken in the course and belong to that specific tag (“top”, “average”, “bottom”)
Passing probability of a unit, Consistency Rate and Average attempts are calculated as follows

$${P}_{pass} ( student , course ) = \frac{No . of Units {passed}_{student , course}}{No . of Units {taken}_{student , course}}$$

$$Consistency Rate ( student , course ) = \frac{No . of line times graded {high}_{student , course}}{No . of Units {taken}_{student , course}}$$

$$Average Attempts ( student , course ) - \frac{No . of unit takes / {attempts}_{student , course}}{Unique No . of {Units}_{student , course}}$$

Students are sorted (in descending order) based on the metrics listed below in descending order of priority:
1. Pₚₐₛₛ(student,course)
2. P(student,“top”,course)
3. Consistency Rate(student,course)
4. P(student,“average”,course)
5. Average Attempts(student,course)
6. P(student,“bottom”,course)

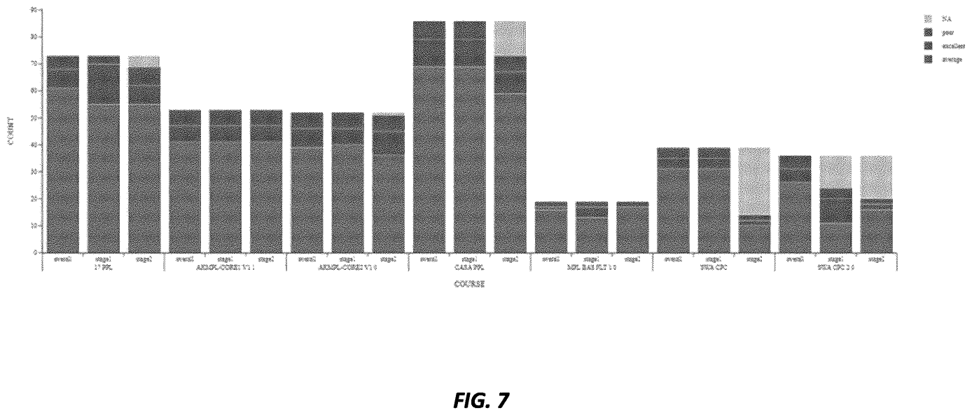

If two students obtain the same values across all the metrics, they are assigned a same rank. After ranking the students in each course, the ones falling within the top 10% (≤0.1 quantile of ranks) are marked as “Above average”, the ones with the bottom 10% of the ranks (>0.9 quantile of ranks) are marked as “Below average”, and the remaining ones are marked as “Average”. The temporal aspect of performance (how students are progressing with time) is also considered in one implementation. Each course is divided into two stages (sections): stage 1 includes roughly the first half of the course and stage 2 includes the latter half and the student performance labels are drawn using the same method explained here, considering only the values assigned to the units of the specific stage. It is important to note that some students would not have attended any units in a particular stage; such instances are marked as “NA” (not available) indicating the non-availability of performance measures for the students in that stage. After performance labelling, the distribution of labels across the courses under consideration in overall and temporal view are summarized graphically in FIG. 7. In the bar chart of FIG. 7, the bars are grouped into trios for each of seven different psychometric tests. In each trio, the first bar represents overall results (excellent, average, poor or not available), the second bar represents first stage results, and the third bar represents second stage results.

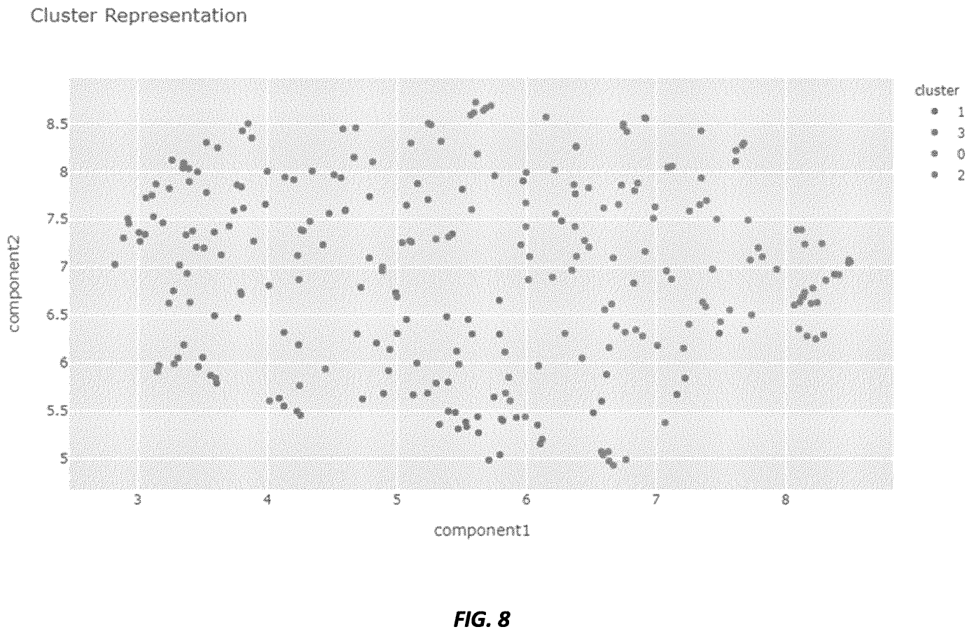

FIG. 8 is a graphical cluster representation showing cluster formation using agglomerative hierarchical clustering. The representation of aptitude test data after reducing the dimensions to 2D for visual representation is shown in FIG. 8.

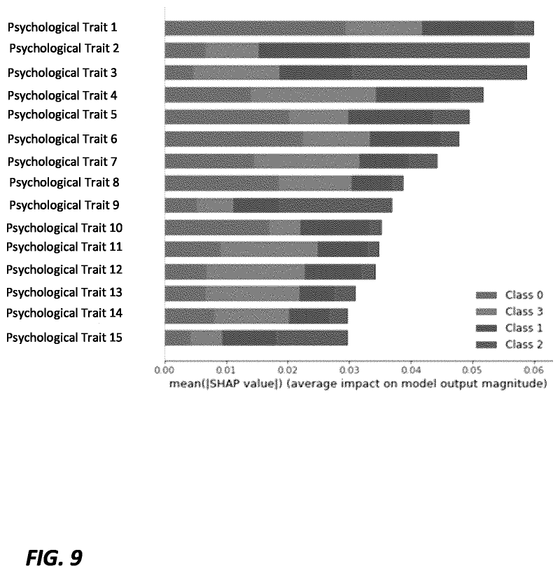

FIG. 9 is a graphical representation of fifteen defining features (psychological traits) of individual clusters. SHAP (SHapley Additive exPlanations) is used to explain the output of the classifier, which is in turn the cluster interpretation. SHAP is a game theory approach to explain the output of any machine learning model. It connects optimal credit allocation with local explanations using the classic Shapley values from game theory and their related extensions.

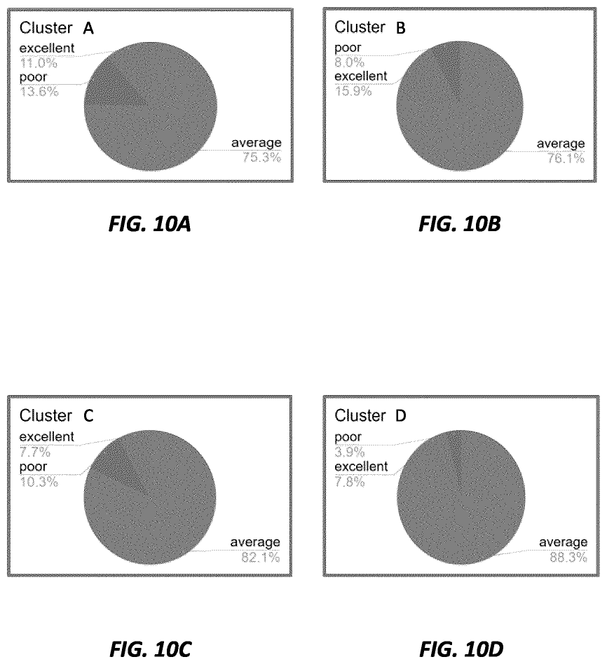

FIGS. 10A, 10B, 10C and 10D are pie chart depicting how each aptitude cluster correlates with predicted performance. In these pie charts, the predicted performance is categorized as excellent, average and poor. The aptitude cluster B of FIG. 10B has the highest likelihood of students achieving excellent performance results. The aptitude cluster D of FIG. 10D has the lowest probability of students performing poorly.

As an example, the clusters A, B, C, and D may be further characterized by respective psychological traits. Some example traits are presented to illustrate the types of psychological traits that may be used in the context of pilot training:

Cluster A: Neurotic, unstable, vulnerable, angry, abnormal, non-trustworthy & NOT a stereotypical pilot

Cluster B: Neither adherent nor a stereotypical pilot; Intelligent, calm, stable while neither company minded nor trustworthy.

Cluster C: Challenged in cognitive, speed and physical skills, while accommodating and trustworthy.

Cluster D: Self-aware, stereotypical pilot, stable, intelligent, trustworthy with scope to develop and adhering to the company values.

Cluster B has the highest percentage of Above Average performance, whereas Cluster D has the least percentage of Below Average performance, which indicates that intelligence, a characteristics that Cluster B and Cluster D have in common, plays a role in performance, be it excellence or avoiding failure. The difference between Cluster B and Cluster D is that candidates within the former cluster are introverted and not stereotypical while those within the latter cluster are extroverted and stereotypical pilot.

Cluster A has the highest percentage of poor performance, even more than Cluster C despite the fact that candidates within Cluster C struggle cognitively. Cluster A has the most significant behavioral problems compared to all other clusters, leading to believe that poor performance is correlated with attitude more than intelligence.

### Temporal Performance

In one embodiment, the individual student performances in the first and second stages of the courses are compared and correlated to understand the relationship between the aptitude and performance progression. In this embodiment, performance improvement has been encoded as an integer number [−2, 2] which represents the level of improvement from the former to the latter stage of the course.
2 indicates a jump from Below Average performance in stage 1 to Above Average performance in stage 2.
1 indicates a jump from Below Average performance in stage 1 to Average performance in stage 2), or from Average performance in stage 1 to Above Average performance in stage 2.
0 indicates a stagnation in performance across both stages.
−1 indicates a fall from Average performance in stage 1 to Below Average performance in stage 2), or from Above Average performance in stage 1 to Average performance in stage 2)
−2 indicates a fall from Above Average performance in stage 1 to Below Average performance in stage 2)

| Aptitude cluster | Improvement | Student Count | Perc. Count |
|---|---|---|---|
| A | 0 | 84 | 61.3% |
| A | −1 | 29 | 21.2% |
| A | 1 | 20 | 14.6% |
| A | −2 | 2 | 1.5% |
| A | 2 | 2 | 1.5% |
| B | 0 | 35 | 59.3% |
| B | −1 | 16 | 27.1% |
| B | 1 | 5 | 8.5% |
| B | 2 | 2 | 3.4% |
| B | −2 | 1 | 1.7% |
| C | 0 | 22 | 75.9% |
| C | −1 | 4 | 13.8% |
| C | 1 | 3 | 10.3% |
| D | 0 | 47 | 75.8% |
| D | −1 | 9 | 14.5% |
| D | 1 | 6 | 9.7% |

It may be noted that candidates in Clusters C and D exhibit the most consistent performance across the stages resulting in significantly higher percentages for cases related to 0 improvement score. The key features common to both Cluster A and B differing from Cluster C & D are Silhouette match, Conscientiousness, Trustworthy, Profile, Development and Company minded. This combination of attributes appears to be linked to consistent performance across stages.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

Some of the foregoing methods can be implemented in hardware, software, firmware or as any suitable combination thereof. That is, if implemented as software, the computer-readable medium comprises instructions in code which when loaded into memory and executed on a processor of a computing device (or computer system) causes the computing device (or computer system) to perform any of the foregoing method steps.

These method steps may be implemented as software, i.e., as coded instructions stored on a computer readable medium which performs the foregoing steps when the computer readable medium is loaded into memory and executed by the microprocessor of the computing device. A computer readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

For the purposes of interpreting this specification, when referring to elements of various embodiments of the present invention, the articles “a”, “an”, “the” and “said” are intended to mean that there are one or more of the elements. The terms “comprising”, “including”, “entailing, “involving” and “having” are intended to be inclusive and open-ended by which it is meant that there may be additional elements other than the explicitly listed elements.

This invention has been described in terms of specific implementations and configurations which are intended to be exemplary only. Persons of ordinary skill in the art will appreciate that many obvious variations, refinements and modifications may be made without departing from the inventive concept(s) presented in this application. The scope of the exclusive right is therefore intended to be limited solely by the appended claims.

1. A system for predicting performance of a student seeking to learn to operate an actual machine based on psychometric data relating to the student, the system comprising:
one or more processors executing computer-readable code from a computer-readable medium to:
obtain the psychometric data relating to a plurality of students who have completed a training course that trains the students to operate the actual machine, the psychometric data having been obtained via psychometric tests taken by the students, the psychometric data being indicative of a plurality of psychological traits of the students;
cluster the psychological traits of the students to define a plurality of aptitude clusters and to correlate the aptitude clusters with performance data from simulation training to thereby associate different levels of performance with each of the plurality of aptitude clusters; and
receive a set of new psychometric data for a new student seeking to learn to operate the actual machine, the new student performance prediction module being further configured to associate the set of new psychometric data for the new student with a selected one of the plurality of aptitude clusters to thereby predict the performance of the new student.

2. The system of claim 1 comprising:
one or more data storage devices for storing a database of the psychometric data relating to the plurality of students who have completed the training course; and
a training management system comprising one or more simulation stations that present interactive computer simulations of the actual machine to the students to provide the simulation training, the one or more simulation stations having tangible instrumentation enabling the student to operate a simulated machine as a virtual representation of the actual machine in the interactive computer simulations as part of the training course, the training management system collecting the performance data for the students.

3. The system of claim 1 comprising:
a simulation input device connected to a personal computing device that is controlled by the student during an elementary simulation of the actual machine from which psychomotor data indicative of the psychomotor skills of the student is obtained,
wherein the one or more processors predict the performance of the student also based on the psychomotor data.

4. The system of claim 1 wherein the one or more processors are configured to generate performance improvement data indicative of how a student is improving over time during the training course.

5. The system of claim 1 wherein the artificial intelligence module is configured to cluster the psychological traits using hierarchical agglomerative clustering.

6. The system of claim 1 wherein the actual machine is an aircraft and the simulation station is a flight simulator.

7. The system of claim 1 wherein the artificial intelligence module generates an individualized training plan based on the selected one of the aptitude clusters and communicates the individualized training plan to a user computing device to be presented to the new student or to a user involved in training the new student, the individualized training plan providing a personalized training program for the student.

8. The system of claim 1 wherein the artificial intelligence module generates a student-machine affinity profile based on the selected one of the aptitude clusters and communicates the student-machine affinity profile to a user computing device to be presented to the new student or to a user involved in training the new student, the student-machine affinity profile indicative of which type of actual machine the student is most suited to operate.

9. A computer-implemented method of predicting performance of a student seeking to learn to operate an actual machine based on psychometric data relating to the student, the method comprising:
obtaining the psychometric data relating to a plurality of students who have completed a training course that trains the students to operate the actual machine, the psychometric data having been obtained via psychometric tests taken by the students, the psychometric data being indicative of a plurality of psychological traits of the students;
using an artificial intelligence module to cluster the psychological traits of the students to define a plurality of aptitude clusters and to correlate the aptitude clusters with the performance data to thereby associate different levels of performance with each of the plurality of aptitude clusters; and
receiving a set of new psychometric data for a new student seeking to learn to operate the actual machine and associating the set of new psychometric data for the new student with a selected one of the plurality of aptitude clusters to thereby predict the performance of the new student.

10. The method of claim 9 comprising:
storing a database of the psychometric data relating to the plurality of students who have completed the training course; and
collecting the performance data for the students training on one or more simulation stations that present interactive computer simulations of the actual machine to the students, the one or more simulation stations having tangible instrumentation enabling the student to operate a simulated machine as a virtual representation of the actual machine in the interactive computer simulations as part of the training course.

11. The method of claim 9 comprising:
obtaining psychomotor data indicative of the psychomotor skills of the student using a simulation input device connected to a personal computing device that is controlled by the student during an elementary simulation of the actual machine; and
predicting the performance of the student also based on the psychomotor data.

12. The method of claim 9 further comprising generating performance improvement data indicative of how a student is improving over time during the training course.

13. The method of claim 9 wherein clustering the psychological traits is performed using hierarchical agglomerative clustering.

14. The method of claim 9 wherein the actual machine is an aircraft and the simulation station is a flight simulator.

15. The method of claim 9 further comprising:
generating an individualized training plan based on the selected one of the aptitude clusters; and
communicating the individualized training plan to a user computing device to be presented to the new student or to a user involved in training the new student, the individualized training plan providing a personalized training program for the student.

16. The method of claim 9 further comprising:
generating a student-machine affinity profile based on the selected one of the aptitude clusters; and
communicating the student-machine affinity profile to a user computing device to be presented to the new student or to a user involved in training the new student, the student-machine affinity profile indicative of which type of actual machine the student is most suited to operate.

17. A non-transitory computer-readable medium storing instructions in code which when executed by one or more processors cause the one or more processors to:
obtain the psychometric data relating to a plurality of students who have completed a training course that trains the students to operate the actual machine, the psychometric data having been obtained via psychometric tests taken by the students, the psychometric data being indicative of a plurality of psychological traits of the students;
execute an artificial intelligence module to cluster the psychological traits of the students to define a plurality of aptitude clusters and to correlate the aptitude clusters with the performance data to thereby associate different levels of performance with each of the plurality of aptitude clusters; and
receive a set of new psychometric data for a new student seeking to learn to operate the actual machine and associating the set of new psychometric data for the new student with a selected one of the plurality of aptitude clusters to thereby predict the performance of the new student.

18. The computer-readable medium of claim 17 comprising:
store a database of psychometric data relating to a plurality of students who have completed a training course that trains the students to operate an actual machine, the psychometric data having been obtained via psychometric tests taken by the students, the psychometric data being indicative of a plurality of psychological traits of the students; and
collect performance data for the students training on one or more simulation stations that present interactive computer simulations of the actual machine to the students, the one or more simulation stations having tangible instrumentation enabling the student to operate a simulated machine as a virtual representation of the actual machine in the interactive computer simulations as part of the training course.

19. The computer-readable medium of claim 17 comprising code that causes the one or more processors to:
obtain psychomotor data indicative of the psychomotor skills of the student using a simulation input device connected to a personal computing device that is controlled by the student during an elementary simulation of the actual machine; and
predict the performance of the student also based on the psychomotor data.

20. The computer-readable medium of claim 17 comprising code that causes the one or more processors to generate performance improvement data indicative of how a student is improving over time during the training course.

21. The computer-readable medium of claim 17 comprising code that causes the one or more processors to use hierarchical agglomerative clustering to cluster the psychological traits.

22. The computer-readable medium of claim 17 wherein the actual machine is an aircraft and the simulation station is a flight simulator.

23. The computer-readable medium of claim 17 comprising code that causes the one or more processors to:
generate an individualized training plan based on the selected one of the aptitude clusters; and
communicate the individualized training plan to a user computing device to be presented to the new student or to a user involved in training the new student, the individualized training plan providing a personalized training program for the student.

24. The computer-readable medium of claim 17 comprising code that causes the one or more processors to:
generate a student-machine affinity profile based on the selected one of the aptitude clusters; and
communicate the student-machine affinity profile to a user computing device to be presented to the new student or to a user involved in training the new student, the student-machine affinity profile indicative of which type of actual machine the student is most suited to operate.
